(19) United States
(12) Patent Application Publication
(10) Pub. No.: US 2005/0104729 A1
(43) Pub. Date: May 19, 2005

(54) Credit card minder

(76) Inventor: Burton F. Grant, Highland Park, IL (US)

Correspondence Address: JONATHAN D. FEUCHTWANG, 150 NORTH WACKER DRIVE, SUITE 1200, CHICAGO, IL, 60606, US

(21) Appl. No.: 10/713,884

(22) Filed: Nov. 14, 2003

(51) Int. Cl. G08B 13/14

(52) U.S. Cl. 340/568.7; 340/572.1

(57) ABSTRACT

Disclosed is a credit card minder which ensures that credit cards are returned to a wallet or carrier within a predetermined time interval. The credit card minder includes a card carrier storing at least one card and a radio tag provided on each card. The radio tag transmitting a first radio frequency signal at periodic intervals including an identifier uniquely identifying the card. A receiver provided in the card carrier receives the first radio frequency signal, and triggers a signaling device if the first radio frequency signal is not received within the specified interval.

### FIELD OF THE INVENTION

The present invention relates to a wallet based system for reminding a user to retrieve his or her credit card.

### BACKGROUND OF THE INVENTION

Credit card and debit card use is currently at a record high. Consumers rely on credit cards and the like on a daily basis for everything from buying a cup of coffee to purchasing groceries. Unfortunately in the hustle and bustle of everyday life it is easy to leave ones credit card at the business establishment. Accordingly, there exists a need for a credit card minder which reminds the user to retrieve his or her card from the sales clerk.

### SUMMARY OF THE INVENTION

A credit card minder system is disclosed for minding at least one credit card, the credit card minder system includes a radio tag provided on each of the at least one credit card, the radio tag transmitting a first radio frequency signal at periodic intervals including an identifier uniquely identifying the at least one card. A housing is provided storing a receiver for receiving the first radio frequency signal. A signaling device responsive to a signal from the receiver is provided in the housing. The receiver issuing a signal to the signaling device if the receiver fails to receive the first radio frequency signal within the periodic intervals. A power source operatively connected to the receiver and the signaling device is also provided in the housing.

According to a further aspect of the invention, the credit card minder system includes a transmitter provided in the housing for transmitting a second radio frequency signal at periodic intervals, the radio tag including a receiver for receiving the second radio frequency signal, and a transmitter for transmitting the first radio frequency signal each time the radio tag receiver receives the second radio frequency signal.

According to yet another aspect of the invention the credit card minder system includes a credit card holder for storing the housing and the at least one credit card.

### BRIEF DESCRIPTION OF THE DRAWINGS

Preferred embodiments of the present invention are described herein with reference to the drawings wherein

FIG. 1 is a block diagram of a first embodiment of the credit card minder of the present invention;

FIG. 2 is a block diagram of a second embodiment of the credit card minder of the present invention; and

FIGS. 3A and 3B are flow diagrams showing the process for training the credit card minder of the present invention.

### DETAILED DESCRIPTION OF THE INVENTION

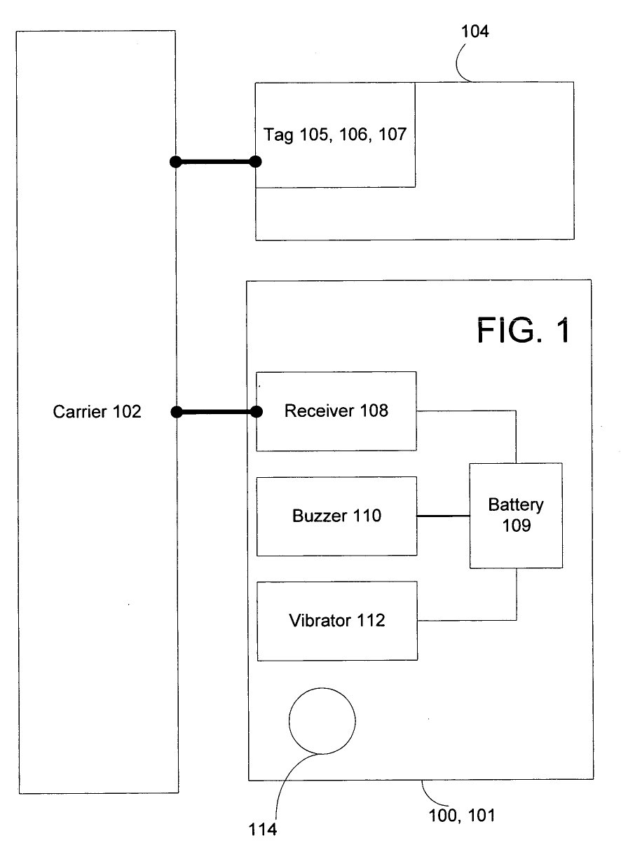

FIG. 1 is a block diagram of a credit card minder system 100 according to the present invention. The credit card minder 100 includes a housing 101 a radio frequency (RF) receiver 108, a power supply 109, and buzzer 110 and/or vibrator 112. The credit card minder is configured to fit into a credit card holder such as wallet or case 102 for storing at least one credit card 104. Each credit card 104 is provided with a radio tag 106 broadcasting a radio frequency signal.

It should be understood that the term credit card used throughout this disclosure includes reference to any object which the user wishes the system to mind. Thus the credit card 104 could be an object such as a driver's license, debit card, social security card or other objects commonly stored in one's wallet.

In operation the radio tag 106 transmits a radio frequency “heart beat” signal via an internal transmitter 107 at predetermined intervals to alert the receiver 108 that the credit card is within range of the wallet 102. The radio tag 106 includes a power supply or battery 105 to power the transmitter 107. If the receiver 108 fails to receive the heart beat signal from one of the radio tags 106 then an alert is triggered. The alert is signaled to the user by actuation of the buzzer 110, vibrator 112 or the like.

The radio tag 106 may be integrally formed with the card 104 or may be attached to the card 104, for example by an adhesive (not illustrated).

It should be understood that the radio frequency signal is being transmitted over a relatively short distance and that the power requirement for transmitting such signal is relatively small. Generally, the radio frequency signal is required to travel less than one inch.

According to a presently preferred embodiment, the radio tag 106 is disposed once the battery 105 is depleted.

As noted above, the receiver 108 is provided with a storage cell 109 such as a battery or the like for storing an electrical charge sufficient to transmit a radio frequency signal. Again, it should be understood that the radio frequency signal is being transmitted over a short distance and that the power requirement for transmitting such signal is relatively small.

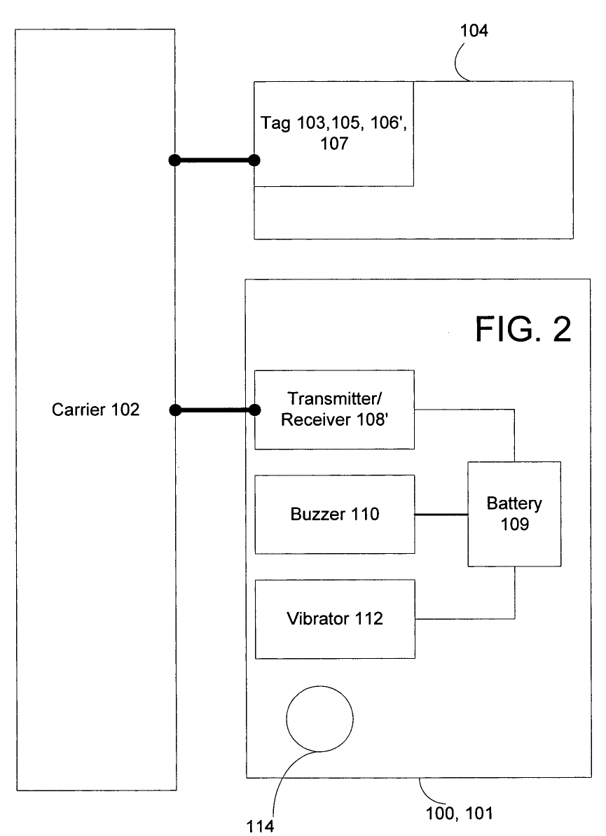

The credit card minder 100 of FIG. 1 uses a so-called active radio tag 106 which autonomously transmits the heart beat signal to the receiver 108 at predefined intervals. FIG. 2 shows an alternative embodiment of the credit card minder 100 in which the active radio tag 106 is replaced with a passive radio tag 106′. The use of a passive radio tag 106′ would further require replacement of the receiver 108 with a transmitter/receiver 108′. In such a system the transmitter/receiver 108′ transmits the heart beat signal, and the passive radio tags 106′ transmit a response or reply signal. If the transmitter/receiver 108′ fails to receive the reply signal from one of the radio tags 106′ then an alert is triggered.

The so-called passive tag 106′ includes receiver 103 in addition to the transmitter 107. The transmitter 107 issues a reply signal each time the receiver 103 receives a heart beat signal from the transmitter/receiver 108′.

The heart beat or reply signal transmitted by the radio tags 106, 106′ include a unique identifier which the receiver 108 or transmitter/receiver 108′ expects to receive.

According to one aspect of the invention, the credit card minder 100 may, by default, expect a predefined identifier or a plurality of predefined identifiers.

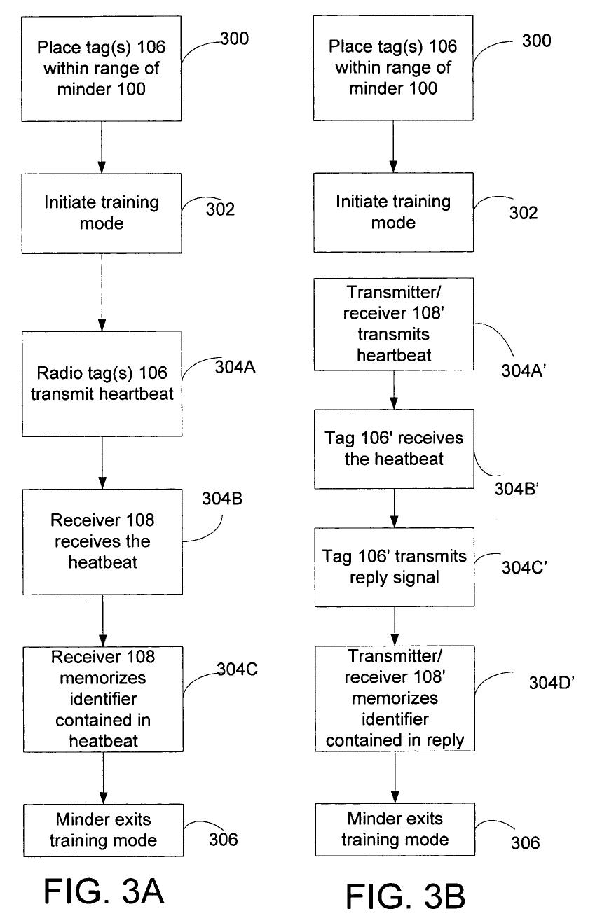

According to a further aspect of the invention, the receiver 108 or transmitter/receiver 108′ may be trained (programmed) to add or delete an identifier (radio tag 106, 106′). FIG. 3 is a flow diagram of a process for introducing a new identifier.

In order to train credit card minder 100, the user must place all of the radio tags 106, 106′ to be recognized within range of the receiver 108 or transmitter/receiver 108′ (step 300). Next the user initiates a training mode by a pushing button 114 using a needle or the like (step 302).

The credit card minder 100 will then memorize each identifier received within a predetermined time period (step 304), and exit the training mode (step 306).

More particularly, in a credit card minder 100 having a receiver 108 the radio tags 106 will each transmit the heartbeat signal (step 304A), the receiver 108 will receive the heartbeat (step 304B) will memorize the identifier contained the in heartbeat (step 304C).

Correspondingly, in a credit card minder 100 having a transmitter/receiver 108′, the transmitter/receiver 108′ will transmit the heartbeat signal (step 304A′), each of the radio tags 106′ receiving the heartbeat (step 304B′) will transmit a reply signal (step 304C′), and the credit card minder 100 will memorize the identifier contained in each reply signal (step 304D′).

Other methods for training the receiver 108 or transmitter/receiver 108′ may readily be employed without departing from the scope and spirit of the present invention.

While various embodiments of the present invention have been shown and described, it should be understood that other modifications, substitutions and alternatives may be apparent to one of ordinary skill in the art. Such modifications, substitutions and alternatives can be made without departing from the spirit and scope of the invention, which should be determined from the appended claims.

1. A credit card minder system for minding at least one credit card, said credit card minder system comprising:
a radio tag provided on each of the at least one credit card, said radio tag transmitting a first radio frequency signal at periodic intervals including an identifier uniquely identifying the at least one card;
a housing;
a receiver provided in said housing for receiving said first radio frequency signal;
a signaling device responsive to a signal from said receiver, said receiver issuing a signal to said signaling device if said receiver fails to receive said first radio frequency signal within said periodic intervals; and
a power source operatively connected to said receiver and said signaling device.

2. The credit card minder system according to claim 1 further comprising:
a transmitter provided in said housing for transmitting a second radio frequency signal at periodic intervals, said radio tag including a receiver for receiving said second radio frequency signal, and a transmitter for transmitting said first radio frequency signal each time said radio tag receiver receives said second radio frequency signal.

3. A credit card minder system comprising:
a credit card holder for storing at least one credit card;
a radio tag provided on each of the at least one credit card, said radio tag transmitting a first radio frequency signal at periodic intervals including an identifier uniquely identifying the at least one card;
a housing;
a receiver provided in said housing for receiving said first radio frequency signal;
a signaling device responsive to a signal from said receiver, said receiver issuing a signal to said signaling device if said receiver fails to receive said first radio frequency signal within said periodic intervals; and
a power source operatively connected to said receiver and said signaling device.

4. The credit card minder system according to claim 1 further comprising:
a transmitter provided in said housing for transmitting a second radio frequency signal at periodic intervals, said radio tag including a receiver for receiving said second radio frequency signal, and a transmitter for transmitting said first radio frequency signal each time said radio tag receiver receives said second radio frequency signal.
